(19) United States
(12) Patent Application Publication
(10) Pub. No.: US 2004/0236629 A1
(43) Pub. Date: Nov. 25, 2004

(54) Method and system for qualifying and effectuating electronic transactions

(76) Inventor: Wayne Martin, Coral Springs, FL (US)

Correspondence Address: Gregory P. Silberman, Kaye Scholer LLP, 425 Park Avenue, New York, NY, 10022, US

(21) Appl. No.: 10/444,007

(22) Filed: May 21, 2003

(51) Int. Cl. G06F 17/60

(52) U.S. Cl. 705/14

(57) ABSTRACT

A method and system in which users engage in fee-based lotteries, and the users have the convenience of partaking in the lottery electronically using, for example, a user interface device in communication with an electronic server, when certain qualification criteria are met. This is accomplished by receiving registration and eligibility information electronically from a user who wishes to participate in an electronic lottery, qualifying the user and accepting play information from the user for such participation when such user is qualified to participate in the electronic lottery.

### FIELD OF THE INVENTION

The invention relates to systems and methods for qualifying and effectuating electronic financial transactions, and more particularly to a system and method for qualifying and effectuating electronic lottery transactions.

### BACKGROUND OF THE INVENTION

Presently, publicly available, fee-based lottery programs are regulated by state governments and are available to users in various forms. For example, users of such programs may select a series of numbers (or have numbers randomly selected for them), and then participate in the lottery for a fee. In response to paying the lottery fee and providing (or receiving) selected numbers to a lottery representative, the user receives a ticket identifying the selected numbers. Winning numbers are subsequently drawn by a lottery administrator. If the numbers selected by or for the user matches a predetermined number of the drawn numbers, the user may then redeem a lottery prize by presenting the ticket to a lottery representative.

Other government-regulated lottery type games are also available. For example, users may pay a fee to purchase a lottery game card from a lottery representative or a vending machine. Such cards may be scratched to uncover numbers, letters or other characters or symbols. If a predesignated series of numbers, letters, characters or symbols are uncovered, the card holder is entitled to redeem a prize by presenting the card to a lottery representative.

Each of these lotteries requires a user to visit an establishment that is authorized to sell such lottery tickets or lottery game cards each time the user wishes to buy one or more lottery tickets or lottery game cards. Such a visit is required for both purchasing the lottery ticket or card and for redeeming a prize when the user is a winner. Further, such visits may entail waiting on long lines to make such purchases or redemptions. This is inconvenient not only for the customers trying to buy a lottery ticket but for other customers of the establishment who may be delayed from making other purchases because of the customers' attempts to buy lottery tickets.

In addition to the inconveniences that often arise from visiting establishments to participate in these lotteries, users may be precluded from playing a lottery game if they are unable to visit such establishments, for example, if there is insufficient time to make such a visit before a deadline associated with the lottery or if the user forgets to make a lottery-related purchase or redemption.

Currently, lotteries are available over the Internet which do not require users to visit an establishment to participate in such lotteries. Government regulations, however, do not permit such electronic (such as Internet-based) lotteries to assess a fee to users. Because there are no fees, the lottery prizes are supported by advertising and do not provide the potential return on investment available with fee-based lotteries.

At least one policy for precluding electronic system-based lotteries in which a fee is imposed relates to the difficulty in identifying whether users have met a certain age requirement. For example, it is generally a state interest to restrict minors from partaking in fee-based lotteries. Enabling users to engage in lotteries electronically creates difficulty in confirming the age of a lottery player. In addition, because such lotteries are typically regulated by state governments (i.e., from state to state), it is important that such state governments limit the access to its lotteries to in-state residents or individuals that are present in the state in which the lottery is operated—i.e., another objective that is difficult to enforce by electronic participation, in lieu of in-person enrollment, in a lottery.

### SUMMARY OF THE INVENTION

It is therefore desirable to have a system and method in which users can engage in fee-based lotteries, wherein users can have the convenience of partaking in the lottery electronically using, for example, a user interface device in communication with an electronic server, while the government has assurance that certain qualification criteria are met. This is accomplished by receiving registration and eligibility information electronically from a user who wishes to participate in an electronic lottery, qualifying the user and accepting play information from the user for such participation when such user is qualified to participate in the electronic lottery.

In accordance with an embodiment of the invention, a system and method are employed for enrolling users in an electronic lottery, including receiving a request from a user to participate in the electronic lottery, receiving qualification data from the user, and then determining whether, based on the received qualification data, the user is eligible to participate in the electronic lottery.

In accordance with another embodiment of the invention, a system and method are employed for enrolling users in an electronic lottery, including receiving a request from a user to participate in an electronic lottery, receiving qualification data from the user, transmitting the qualification data to a third party to confirm the veracity of the qualification data, receiving information indicating whether the veracity of the qualification data is confirmed, and determining whether, based on the received qualification data, the user is eligible to participate in the at least one electronic lottery. The system and method may also be configured for compiling demographic information relating to users based upon qualification data and/or registration data received from such users.

In accordance with yet another embodiment of the invention, a system and method are employed for effectuating an electronic lottery, including receiving a request from a user to participate in the electronic lottery, generating electronic tickets, wherein the electronic ticket relate to the user request, and debiting funds from the user for each electronic ticket that is generated. The system and method may also be configured for assessing one or more transaction fees for effectuating the electronic lottery.

### BRIEF DESCRIPTION OF THE DRAWINGS

Further objects, features and advantages of the invention will become apparent from the following detailed description taken in conjunction with the accompanying drawings showing illustrative embodiments of the invention, in which:

FIG. 1 is a diagram illustrating an electronic lottery system in accordance with an embodiment of the invention;

FIG. 1 is a block diagram illustrating a data storage device and components of a server used in the system of FIG. 2;

FIG. 3 is a flowchart illustrating the process of registering and qualifying users accessing the electronic lottery system of FIG. 1; and

FIG. 4 is a flowchart illustrating the process of enrolling users in an electronic lottery in accordance with an embodiment of the invention.

### DETAILED DESCRIPTION

The invention is directed to qualifying and effectuating electronic financial transactions, and more particularly to a system and method for qualifying and effectuating electronic lottery transactions. As described below, this is accomplished by receiving registration and eligibility information electronically from a user who wishes to participate in an electronic lottery, qualifying the user and accepting play information from the user for such participation when such user is qualified to participate in the electronic lottery.

It should be noted at this point that the term “traditional lottery” is defined as a scheme in which one or more users visit a predesignated establishment (i.e., a point of sale) for paying a fee to purchases one or more chances (e.g., in the form of numbers selected by or assigned to a user) to win a prize resulting from a drawing. Typically, one or more users win such a prize when the chance(s), or portion thereof, matches the results of the drawing. In a typical traditional lottery, winners must then visit one of a number of predesignated establishments to redeem a prize.

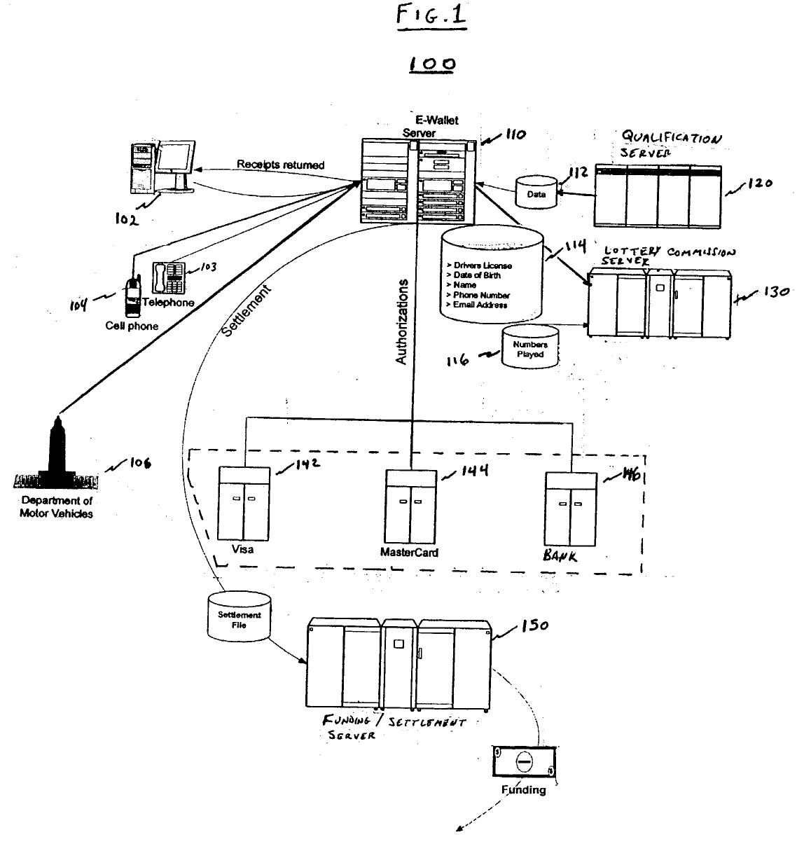

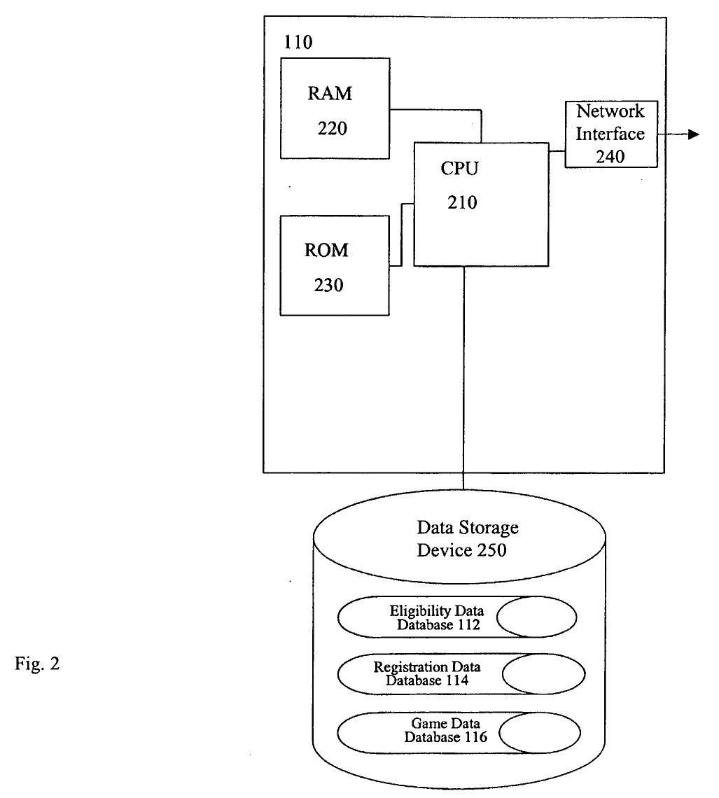

An “electronic lottery” is defined herein as a lottery in which one or more users have the opportunity to purchase the lottery chance(s) and/or redeem the lottery prize(s) electronically—for example, over the Internet, telecommunications network, etc.—as opposed to being required to make such purchase or redemption from a lottery representative or vending machine via visiting an establishment. In an embodiment of the invention, an electronic lottery enables users to participate in a traditional lottery through an electronic system, such as the system described below with reference to FIG. 1, thereby obviating the need for the user to visit an establishment to participate in the traditional lottery. In an alternate embodiment, an electronic lottery is a lottery that is electronically accessible to users and is unrelated to a traditional lottery.

“Qualifying”, “qualification”, “eligible” and “eligibility” are terms defined herein as the process of collecting certain user data from a user and confirmation data from a third party to confirm that the user is eligible, in accordance with an embodiment of the invention, to enroll and participate in the electronic lottery accessible by system 100.

FIG. 1 illustrates system 100 which is configured for qualifying and effectuating electronic lottery transactions in accordance with an embodiment of the invention. A user may access system 100 in various ways. For example, a user may use an interface device, such as computer 102, landline telephone 103 or cellular telephone 104 to access system 100. System 100 may be accessed by other user interface devices (not shown), including a fax machine, personal digital assistant (PDA) having Internet access, short message service (SMS) device, and the like. In addition, a user may mail registration and qualification information to a predesignated location to be inputted in electronic form by an interface device, such as one of those provided above. In yet another embodiment of the invention, a user may visit a predesignated location, such as a governmental office (e.g., Department of Motor Vehicle Office 106) or some other establishment affiliated with system 100 to provide registration and qualification information for inputting in electronic form by an interface device, such as one of those provided above.

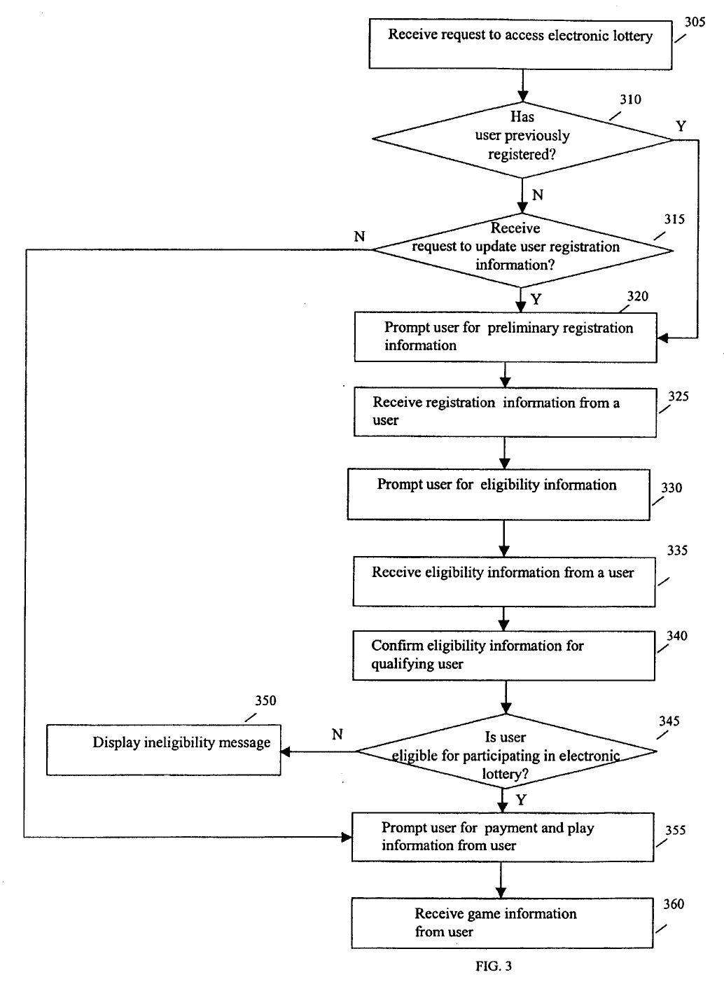

The registration and qualification information (which is described below with reference to FIG. 3) is transmitted from an interface device to e-wallet server 110 and stored in one more databases, such as Eligibility Data Database 112 and/or Registration Data Database 114.

FIG. 2 illustrates components of server 110 and a data storage device 250 including Eligibility Data Database 112, Registration Data Database 114 and Game Data Database 116. It should be noted that server 110 may be remotely located from data storage device 250 or may be integrated with storage device 250. It should be further noted that, although three databases 112, 114 and 116 and one data storage device 250 are illustrated and described, the data accessed by server 110 may all be stored in one database and data storage device or among several databases and/or data storage devices in various manners which are well known to those skilled in the art.

Server 110 preferably includes standard hardware components, such as central processing unit (CPU) 210, a random access memory (RAM) 220, a read only memory 230 and communications port or network interface 240. The CPU 210 is preferably linked to each of the other listed elements, either by means of a shared data bus, or dedicated connections, as shown in FIG. 2.

CPU 210 may be embodied as a single commercially available processor, or, in another embodiment, the CPU 310 may be embodied as a number of such processors operating in parallel.

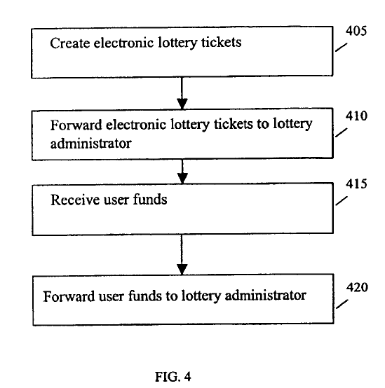

ROM 230 is operable to store one or more instructions, discussed further below in conjunction with FIGS. 3 and 4, which the CPU 210 is operable to retrieve, interpret and execute. For example, ROM 230 preferably stores processes to receive, process and transmit data for registering and qualifying users engaging in electronic lottery transactions as described below, as well as effectuating electronic lotteries which is also described below.

CPU 210 preferably includes a control unit, an arithmetic logic unit (ALU), and a CPU local memory storage device, such as, for example, a stackable cache or a plurality of registers, in a know manner. The control unit is operable to retrieve instructions from the ROM 230. The ALU is operable to perform a plurality of operations needed to carry out instructions. The CPU local memory storage device is operable to provide high-speed storage used for storing temporary results and control information.

Data storage device 250 includes, in one embodiment, Eligibility Data Database 112, Registration Data Database 114 and Game Data Database 116. Eligibility Data Database 112 preferably stores information relating to whether a user is eligible to participate in the electronic lottery offered by system 100. In an embodiment of the invention, such information includes user age (e.g., derived from date of birth information) and/or residence information (e.g., user town/city, state and/or zip code). In addition, Registration Data Database 114 preferably stores information relating to a user's name, identification (ID) code and password for accessing system 100 (as described below), user contact information (e.g., mailing address, telephone number, e-mail address), bank information (e.g., bank name, bank routing number, account number) and/or credit card information (e.g., credit card type, credit card number, credit card expiration date). In accordance with an embodiment of the invention, user ID code and password information is used by server 110 to create a user account for subsequent access by a user.

Game Data Database 116 preferably stores information relating to the user's electronic lottery play options, including the specific electronic lottery game(s) that the user wishes to play, the numbers that the user wishes to play (e.g., specific numbers specified by the user, random numbers generated by e-wallet server 110), whether the user wishes to be enrolled in the lottery automatically or only when designated by the user on a game-by-game basis, as well as the frequency the user wishes to play the lottery when the automatic enrollment option is exercised.

Network interface 240 connects server 110 to user interface devices, such as devices 102, 103 and 104 (shown in FIG. 1), and other servers of system 100, such as qualification server 120, lottery commission server 130, Visa server 142, MasterCard server 144, bank server 146 and settlement/funding server 150. Referring to FIG. 1, qualification server 120 provides information for confirming data provided by the user is accurate. For example, if a user provides information to server 110 indicating that the user is a twenty year old resident of New York, information stored by server 120 is, in accordance with an embodiment of the invention, accessed for confirming the veracity of the user's age and/or residence information. In an embodiment of the invention, the data provided by qualification server 120 may be data from a governmental Department of Motor Vehicles, or some other governmental entity that has access to records relating to the user for confirming user qualification (e.g., residency, age) information.

Lottery commission server 130 is also in communication with server 110. Lottery commission server 130 is configured for receiving registration data and game data from server 110 to effectuate user participation in an electronic lottery. In an embodiment of the invention, only the data required to identify the user and the user's play options that are required to enroll the user in specified lottery game(s) is sent to server 130. Thus, for example, because server 110 performs the qualification, settlement and funding procedures as described below with reference to FIGS. 3 and 4, qualification data and certain user registration data need not be sent to lottery commission server 130 for user participation in an electronic lottery game. For example, in accordance with an alternate embodiment of the invention, settlement and funding information is reported to the lottery commission in a predetermined format on a periodic basis (e.g., monthly, quarterly, etc.).

Each time a user participates in an electronic lottery game by accessing system 100, server 110 processes a user fee by debiting the lottery fee amount from the user's credit card account, such as Visa 142, MasterCard 144, etc., or bank account from, for example, bank 146, or some other financial institution affiliated with the user. Upon collecting the fees from the accounts of users that are participating in a given electronic lottery game, server 110 transmits (i.e., settles) the funds by transmitting the collected fees to funding server 150 (e.g., in the form of a wire transfer) which, in accordance with an embodiment of the invention, is operated, controlled and/or accessible by the lottery commission.

FIG. 3 illustrates a flowchart depicting a process for registering and qualifying users accessing electronic lottery system 100. At step 305, server 110 receives a request from a user to access electronic lottery system 100. The request, in this example, is transmitted through the Internet which is accessed by the user's computer 102. At step 310, server 110 then determines whether the user has previously registered with the electronic lottery system. This is accomplished, in accordance with an embodiment of the invention, by displaying a login prompt which users that have previously registered with the electronic lottery system can provide a user ID and password in response to the prompt for further access to the system.

Users, however, that access system 100 but have not previously registered (and therefore do not have an ID code and password) are prompted to provide preliminary registration information (step 320). Additionally, users that have previously registered with system 100 but have indicated a desire to update registration information (step 315) are also prompted for the provision of user registration information (step 320). In accordance with an embodiment of the invention, a link is made available to a user which, when selected, enables the user to input registration information. If, in an alternate embodiment of the invention, the user accesses server 110 using a telephonic device, such as telephone 103 or 104, the user can access such update option by pressing a key on the user's telephone pad—e.g., the star (“*”) key—which is dedicated to initiate the option.

As described above, the user registration data received from a user and stored by Registration Data Database 114 (step 325) includes the user's name, ID code, password, contact information, bank information, and/or credit card information. In addition, the user is also prompted for submitting eligibility data information (step 330). As described above, the user eligibility data received from a user and stored by Eligibility Data Database 114 (step 335) includes the user's age and/or residence information.

At step 340, server 110 then confirms the eligibility information provided by the user. In accordance with an embodiment of the invention, the eligibility information is any information that must be associated with a user and confirmed by a third party in order to qualify for participating in the electronic lottery provided by system 100. In one embodiment, users are eligible to participate in an electronic lottery if the user has met a certain age requirement (e.g., over eighteen years old) and such eligibility criterion is confirmed. In a second embodiment, users are eligible to participate in an electronic lottery if the user is a resident of a state in which the electronic lottery is regulated and such eligibility criterion is confirmed. In yet another embodiment, eligibility is met when a user meets a predetermined age requirement and meets a predetermined residency and such eligibility criteria is confirmed.

Server 110 confirms the veracity of the eligibility information provided by a user by accessing data from qualification server 120—which as described above may be data provided by a governmental Department of Motor Vehicles, or some other governmental entity that has access to data for confirming user qualification (e.g., residency, age) information.

If the veracity of the eligibility information is not confirmed by the information sent from qualification server 120 to server 110, a message is provided to the user's interface device indicating that the user is ineligible to participate in the electronic lottery (step 350). If, however, the user's eligibility information is confirmed, the user is then prompted to provide game information (e.g., information relating to the user's electronic lottery play options, specific electronic lottery game(s) that the user wishes to play, the numbers that the user wishes to play, whether the user wishes to be enrolled in the lottery automatically, etc.) (step 355) for transmission to server 110 (step 360).

Returning to step 315, if a user has previously registered with system 100 and does not indicate a desire to update the user registration information, steps 320 through 350 are skipped and the user is then prompted to provide game information (355) for transmission to server 110 (step 360).

Upon receiving a user's registration, eligibility and game information, e-wallet server 110 is prepared to provide the information required to enroll users in electronic lottery and to effectuate such an electronic lottery.

FIG. 4 illustrates a flowchart depicting a process for enrolling users in an electronic lottery. At a predetermined time prior to conducting the next electronic lottery, electronic lottery tickets are generated for each chance (i.e., lottery game play) purchased by user of system 100 for that lottery (step 405). At this point, in accordance with an embodiment of the invention, system 100 no longer permits additional chances to be purchased for that next scheduled electronic lottery.

It should be noted that each electronic lottery ticket comprises user identification data for identifying the user that purchased the chance and the game data (e.g., numbers to be played) which, if matched with the drawn data (either exactly or partially based upon a predetermined set of business rules associated with the lottery), user(s) whose tickets include the matched data receive a prize. The generated electronic lottery tickets are stored by e-wallet server 110 and a copy of such electronic tickets are forwarded to lottery commission server 130 (step 410).

Server 110 also receives user funds, which are the fees users agree to pay for participating in the electronic lottery (step 415), and the funds, once collected, are then forwarded by server 110 to the lottery commission's financial institution (step 420). At this point, users are enrolled for participating in the upcoming electronic lottery, lottery commission server 130 has the information necessary to effectuate the lottery drawing and the user funds have been received by the lottery commission.

Upon conducting the lottery, lottery commission server 130 sends a message to e-wallet server 110 indicating which users of system 100, if any, won the lottery. A user may then access server 110 and log into the user's account to identify whether any of the user's chances entitled that user to a prize. In an embodiment of the invention, such information is available to a user up until the expiration date in which a user can collect a prize. In another embodiment of the invention, e-wallet server 110 sends a message to a user's interface device to inform the user that one or more of the user's chances entitles the user to a prize when the user's chance(s) and game data match (exactly or partially in accordance with predetermined business rules of the lottery).

As described above, Game Data Database 116 stores information relating to the user's electronic lottery play options, including, among other things, the numbers that the user wishes to play (e.g., specific numbers specified by the user, random numbers generated by system 100), whether the user wishes to be enrolled in the lottery automatically, as well as the frequency the user wishes to play the lottery when the automatic enrollment option is exercised. Accordingly, by selecting such an automatic enrollment option, users can automatically participate in lotteries without having to manually select numbers, purchase chance(s) and identify which lotteries to be played.

It should be noted that, in accordance with an embodiment of the invention, user eligibility information (e.g., residency) is confirmed at the point of initial registration and periodically thereafter. In one embodiment, the periodic confirmation is performed on a monthly, quarterly or annual basis. In another embodiment, the confirmation is performed each time a user participates in a lottery.

The system and processes described herein relate to a lottery system which is principally accessed through the Internet or a telecommunications (landline or cellular) system. It should be noted that the system and processes may be configured for user registration, access, qualification and enrollment to other types of fee-based and non-fee-based games in which user qualification and/or automatic enrollment is desired, and for the effectuation of such games. Thus, such system and processes may be configured for handling electronic sweepstakes, keno and the like. Moreover, such system and processes may be configured for handling other financial transactions in which user residency and/or age data is qualified electronically. In addition, other types of networks, including cable networks, may be used to connect one or more of the servers or other devices of system 100 to one another.

It should be noted that the system and processes described above with reference to FIGS. 1-4 can also be used to collect demographic information respecting users of such electronic lottery system. Because data storage device 250 collects information relating to, among other things, a user's residence, age and home location, it is possible to collect data and analyze such data to identify individual user or user group characteristics. For example, the median age of electronic lottery players, the distribution of such players with respect to one or more geographic locations and the average amount of money (in fees) spent by individual users or a group of users may be monitored.

It should be further noted that, in accordance with an embodiment of the invention, the entity that operates e-wallet server 110 (i.e., “transaction entity”) and/or one or more of the processes performed by e-wallet server 110 may collect a fee for each transaction and/or option initiated by a user. Thus, for example, such transaction entity may assess a transaction fee (e.g., 10% of the chance purchase fees) to either the user, lottery commission, or both. In addition, such “transaction entity” may charge a user a fee each time the user checks the drawn numbers of a lottery that was conducted beyond a predetermined point in the past (e.g., lotteries that took place more than two weeks earlier) or to have a message automatically sent to the user after a lottery in which the user participated is complete or only in the event that the user is a winner of a lottery.

The foregoing merely illustrates the principles of the invention. It will thus be appreciated that those skilled in the art will be able to devise numerous other arrangements which embody the principles of the invention and are thus within its spirit and scope.

For example, system 100 is disclosed herein in a form in which various functions are performed by discrete servers. However, any one or more of these functions could equally well be embodied in an arrangement in which the functions of any one or more of those servers or indeed, all of the functions thereof, are realized, for example, by a different configuration or number of servers.

What is claimed is:

1. A method for enrolling a user in at least one electronic lottery, comprising:
receiving a request from a user to participate in at least one electronic lottery;
receiving qualification data from the user; and
determining whether, based on the received qualification data, the user is eligible to participate in the at least one electronic lottery.

2. The method of claim 1, wherein the qualification data relates to residence information of said user.

3. The method of claim 1, wherein the qualification data relates to age information of said user.

4. The method of claim 1, wherein the qualification data relates to residence information and age information of said user.

5. The method of claim 1, wherein determining whether the user is eligible to participate in the at least one electronic lottery is based upon a confirmation received from a third party.

6. The method of claim 5, wherein the third party is a governmental entity.

7. The method of claim 6, wherein the confirmation is received each time the user participates in the electronic lottery.

8. The method of claim 6, wherein the confirmation is received periodically.

9. A method for enrolling a user in at least one electronic lottery, comprising:
receiving a request from a user to participate in at least one electronic lottery;
receiving qualification data from the user;
transmitting the qualification data to a third party to confirm the veracity of the qualification data;
receiving information for indicating whether the veracity of the qualification data is confirmed;
determining whether, based on the received qualification data, the user is eligible to participate in the at least one electronic lottery.

10. The method of claim 91, further comprising:
receiving at least one electronic lottery play option from the user.

11. The method of claim 10, wherein the at least one electronic lottery play option relates to identifying at least one electronic lottery in which the user requests to participate.

12. The method of claim 10, wherein the least at one electronic lottery play option relates to automatic participation is the at least one electronic lottery.

13. The method of claim 10, wherein the least at one electronic lottery play option relates to game data to be played by the user in the at least one electronic lottery.

14. The method of claim 12, wherein the least at one electronic lottery play option relates to a frequency in which the user participates in the at least one electronic lottery when an automatic participation option is selected.

15. The method of 9, further comprising:
compiling demographic information relating to the user based upon the received qualification data.

16. A method for effectuating at least one electronic lottery, comprising:
receiving at least one request from at least one user to participate in at least one electronic lottery;
generating at least one electronic ticket, wherein the at least one electronic ticket relates to the at least one request; and
debiting funds from at least one account of the at least one user for each of said at least one electronic ticket that is generated.

17. The method of claim 16, further comprising:
transmitting the debited funds to an administrator of the at least one electronic lottery game.

18. The method of claim 16, further comprising:
transmitting the at least one electronic ticket to an administrator of the at least one electronic lottery game.

19. The method of claim 16, further comprising:
identifying whether at least one user is a winner of the at least one electronic lottery.

20. The method of claim 19, further comprising:
transmitting winner information to at least one user indicating whether the at least one user is a winner of the at least one electronic lottery.

21. The method of claim 20, wherein the winner information is transmitted automatically to a user interface device of the at least one user.

22. The method of claim 16, further comprising:
assessing a transaction fee for effectuating the at least one electronic lottery.

23. The method of claim 16, further comprising:
assessing a transaction fee for each of the at least one electronic ticket generated.

24. The method of claim 16, further comprising:
assessing a transaction fee based upon the debited funds.

25. The method of claim 20, further comprising:
assessing a transaction fee based for transmitting said winner information.

26. A system for enrolling a user in at least one electronic lottery, comprising:
a storage for receiving a request from a user to participate in at least one electronic lottery; and
a processor for receiving qualification data from the user, and for determining whether, based on the received qualification data, the user is eligible to participate in the at least one electronic lottery.

27. The system of claim 26, wherein the qualification data relates to residence information of said user.

28. The system of claim 26, wherein the qualification data relates to age information of said user.

29. The system of claim 26, wherein the qualification data relates to residence information and age information of said user.

30. The system of claim 26, wherein the processor is further configured for receiving a confirmation received from a third party for determining whether the user is eligible to participate in the at least one electronic lottery.

31. The system of claim 30, wherein the third party is a governmental entity.

32. The system of claim 31, wherein the processor receives the confirmation each time the user participates in the electronic lottery.

33. The system of claim 31, wherein the processor receives the confirmation periodically.

34. A system for enrolling a user in at least one electronic lottery, comprising:
a storage for receiving a request from a user to participate in at least one electronic lottery, for receiving qualification data from the user, and for receiving information for indicating whether the veracity of the qualification data is confirmed; and
a processor for transmitting the qualification data to a third party to confirm the veracity of the qualification data, and for determining whether, based on the received qualification data, the user is eligible to participate in the at least one electronic lottery.

35. The system of claim 34, wherein the storage further receives at least one electronic lottery play option from the user.

36. The system of claim 35, wherein the at least one electronic lottery play option relates to identifying at least one electronic lottery in which the user requests to participate.

37. The system of claim 35, wherein the at least one electronic lottery play option relates to automatic participation is the at least one electronic lottery.

38. The system of claim 35, wherein the at least one electronic lottery play option relates to game data to be played by the user in the at least one electronic lottery.

39. The system of claim 37, wherein the at least one electronic lottery play option relates to a frequency in which the user participates in the at least one electronic lottery when an automatic participation option is selected.

40. The system of claim 34, wherein the processor is further configured for compiling demographic information relating to the user based upon the received qualification data.

41. A system for effectuating at least one electronic lottery, comprising:
a storage for receiving at least one request from at least one user to participate in at least one electronic lottery; and
a processor for generating at least one electronic ticket, wherein the at least one electronic ticket relates to the at least one request, and for debiting funds from at least one account of the at least one user for each of said at least one electronic ticket that is generated.

42. The system of claim 41, wherein the processor is further configured for transmitting the debited funds to an administrator of the at least one electronic lottery game.

43. The system of claim 41, wherein the processor is further configured for transmitting the at least one electronic ticket to an administrator of the at least one electronic lottery game.

44. The system of claim 41, wherein the processor is further configured for identifying whether at least one user is a winner of the at least one electronic lottery.

45. The system of claim 44, wherein the processor is further configured for transmitting winner information to at least one user indicating whether the at least one user is a winner of the at least one electronic lottery.

46. The system of claim 45, wherein the processor automatically transmits the winner information to a user interface device of the at least one user.

47. The system of claim 41, wherein the processor is further configured for assessing a transaction fee for effectuating the at least one electronic lottery.

48. The system of claim 41, wherein the processor is further configured for assessing a transaction fee for each of the at least one electronic ticket generated.

49. The system of claim 41, wherein the processor is further configured for assessing a transaction fee based upon the debited funds.

50. The system of claim 45, wherein the processor is further configured for assessing a transaction fee based for transmitting said winner information.
